(19) United States
(12) Patent Application Publication
(10) Pub. No.: US 2020/0147899 A1
(43) Pub. Date: May 14, 2020

(54) Mechanical Interface for Retaining Adhesive Material

(71) Applicant: Zephyros, Inc., Romeo, MI (US)

(72) Inventor: Kyle Royston, Romeo, MI (US)

(21) Appl. No.: 16/676,654

(22) Filed: Nov. 7, 2019

Related U.S. Application Data
(60) Provisional application No. 62/757,867, filed on Nov. 9, 2018.

(51) Int. Cl. B29C 65/00; B29C 65/48

(52) U.S. Cl. CPC B29C 66/3034; B62D 25/04; B29C 66/12423; B29C 65/48

(57) ABSTRACT

A reinforcing member comprising: (a) a carrier; and (b) an adhesive material disposed on the carrier, wherein the carrier or the adhesive material includes one or more integrally formed projections configured to mechanically secure the adhesive material to the carrier.

### FIELD

The present teachings generally relate to a structural reinforcing member, and more particularly, to mechanically interlocking adhesive material to a carrier of the structural reinforcing member.

### BACKGROUND OF THE INVENTION

For many years, various industries have been concerned with designing and providing activatable materials to improve structural characteristics of articles such as: adhesion; baffling, sealing; noise and/or vibration dampening; strength reinforcement; other structural characteristics; or a combination thereof. An exemplary industry requiring ongoing improvements to activatable materials is the automotive industry and articles of manufacture for automotive vehicles. It has become increasingly important to provide reinforcing materials that are light-weight, cost-effective, and easy to assemble to maintain cost of vehicles while increasing structural integrity.

To meet the above demands, attempts have been made to dispose an adhesive material on a substrate or carrier to form a reinforcing member. The reinforcing member may then be inserted into a desired location of the vehicle, such as a cavity or hollow structure, prior to activation of the adhesive material. Once the reinforcing member is positioned in the desired location, the adhesive material may then be activated to adhere, expand, or both and increase localized structural support in the desired location. However, challenges often arise when the adhesive material is secured to the substrate or carrier. The adhesive material may inadvertently release from the substrate or carrier, or may be difficult to secure to the substrate or carrier, resulting in a vehicle or article of manufacture not being sufficiently reinforced. Attempts have been made to improve connection of the adhesive material to the carrier by utilizing secondary fasteners, adhesives, or both. However, both aforementioned improvements require additional components and/or materials, cost, manufacturing time, or a combination thereof. Additionally, the secondary fasteners and adhesives often increase the overall dimensions of the reinforcing member, resulting in packaging and assembly issues.

Examples of reinforcing members having an activatable material are disclosed in U.S. Pat. Nos. 7,144,071; 7,255,388; 7,790,280; 8,741,094; 8,808,478; 8,967,327; and 9,427,902; U.S. Publication Nos. 2005/0212332; 2005/0230027; 2014/0292029; and 2018/0050474; and PCT Publication Nos. WO2012/062448; WO2012/143305; and WO2018/025076, all of which are incorporated by reference herein for all purposes. It would be attractive to have an alternative reinforcing member that provides an improved joining of the adhesive material to the carrier or substrate. What is needed is a reinforcing member mechanically connecting the adhesive material to the carrier or substrate. It would be attractive to have a reinforcing member that decreases packaging size and overall dimensions for ease of installation in an article of manufacture. What is needed is a reinforcing member free of secondary fasteners or adhesives joining the adhesive material to the carrier or substrate. It would be attractive to have a reinforcing member that provides an improved method of assembly. What is needed is a reinforcing member having one or more flexible projections configured to removably secure the adhesive material to the carrier or substrate.

### SUMMARY

The present teachings meet one or more of the present needs by providing a reinforcing member comprising: (a) a carrier; and (b) an adhesive material disposed on the carrier, wherein the carrier or the adhesive material includes one or more integrally formed projections configured to mechanically secure the adhesive material to the carrier.

The present teachings meet one or more of the present needs by providing a reinforcing member comprising: (a) a carrier having one or more receiving portions; and (b) an adhesive material disposed on the carrier, the adhesive material having one or more integrally formed projections configured to mechanically secure the adhesive material to the carrier, the one or more projections each comprising a mating portion located near an end of the projection opposing the surface of the adhesive material, wherein each of the one or more projections extend through a respective hole of the carrier and the mating portion of each of the one or more projections has a width greater than a width of their respective hole; wherein the mating portions are received by the one or more receiving portions, and the one or more receiving portions have a complimentary shape that substantially follows and abuts a shape of the mating portion so that the adhesive material is mechanically interlocked to the carrier; and wherein the reinforcing member is free of secondary fasteners the secure the adhesive material to the carrier.

The present teachings meet one or more of the present needs by providing a reinforcing member, wherein: the adhesive material includes the one or more projections; the carrier includes the one or more projections; the one or more projections each include a shaft that extends through a respective hole of the carrier; the one or more projections each include a shaft that extends through a respective hole of the adhesive material; the one or more projections each include a mating portion that is received by a receiving portion of the carrier, and the receiving portion has a complimentary shape that substantially follows and abuts a shape of the mating portion; the one or more projections are elastically deformable; the adhesive material is a thermally expandable material; the mating portion and the receiving portion form a dovetail interface; the one or more projections are a compressible clip; the adhesive material encompasses an exterior profile of the carrier; the holes of the carrier are tapered and the one or more projections are shaped substantially to follow the taper of the holes so that a top surface of the one or more projections is coplanar with a top surface of the carrier; the one or more receiving portions are an outermost profile of the carrier; the one or more receiving portions are integrally formed with the carrier; the carrier is a pair or carriers secured to one another and the one or more receiving portions are a cavity formed between the pair of carriers; or a combination thereof.

The present teachings meet one or more of the present needs by providing: an alternative reinforcing member that provides an improved joining of the adhesive material to the carrier or substrate; a reinforcing member mechanically connecting the adhesive material to the carrier or substrate; a reinforcing member that decreases packaging size and overall dimensions for ease of installation in an article of manufacture; a reinforcing member free of secondary fasteners or adhesives joining the adhesive material to the carrier or substrate; a reinforcing member that provides an improved method of assembly; a reinforcing member having one or more flexible projections configured to removably secure the adhesive material to the carrier or substrate; or a combination thereof.

### BRIEF DESCRIPTION OF THE DRAWINGS

FIG. 1 is a cross-sectional view of a reinforcing member;

FIG. 2 is a cross-sectional view of a reinforcing member;

FIG. 3 is a cross-sectional view of a reinforcing member;

FIG. 4A is a top view of a reinforcing member;

FIG. 4B is cross-sectional side view 4B-4B of FIG. 4A;

FIG. 5 is a cross-sectional view of a reinforcing member;

FIG. 6 is a cross-sectional view of a reinforcing member;

FIG. 7 is a cross-sectional view of a reinforcing member;

FIG. 8 is a cross-sectional view of a reinforcing member having a plurality of adhesive material sections secured to a carrier;

FIG. 9 is a cross-section view of a reinforcing member having an adhesive material secured between carriers;

FIG. 10 is a cross-sectional view of a reinforcing member having an adhesive material encompassing an outer surface of a carrier;

FIG. 11 is a cross-sectional view of a reinforcing member;

FIG. 12 is a cross-sectional view of a reinforcing member having an adhesive material secure in a cavity of a carrier; and

FIG. 13 is a cross-sectional view of a reinforcing member.

### DETAILED DESCRIPTION

The explanations and illustrations presented herein are intended to acquaint others skilled in the art with the teachings, its principles, and its practical application. Those skilled in the art may adapt and apply the teachings in its numerous forms, as may be best suited to the requirements of a particular use. Accordingly, the specific embodiments of the present teachings as set forth are not intended as being exhaustive or limiting of the teachings. The scope of the teachings should, therefore, be determined not with reference to the description herein, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

The teachings herein relate to a reinforcing member. The reinforcing member may function to reinforce one or more articles of manufacture. The one or more articles of manufacture may be configured for one or more industries, such as commercial and/or residential construction, automotive, aeronautical, nautical, transportation, consumer product, or a combination thereof. For example, the reinforcing member may be configured to reinforce an automotive vehicle, a component of an automotive vehicle, or both. The reinforcing member may reinforce a cavity, hollow member, panel, other structure, or a combination thereof. The reinforcing member may reinforce by improving one or more structural characteristics of an article. The one or more structural characteristics may be strength, stiffness, vibration dampening, sealing, noise absorption, thermal insulation, baffling, or a combination thereof. The reinforcing member may include one or more structurally rigid portions, one or more flexible portions, one or more adhesive portions, one or more mechanically interlocking portions, or a combination thereof. For example, the reinforcing member may include a structurally rigid carrier having an expandable adhesive material disposed on the carrier. The reinforcing member may be configured to be inserted into a location on or in an article for localized reinforcement. For example, the reinforcing member may be inserted into a cavity of one or more pillars of an automotive body (i.e., A-pillar, B-pillar, C-pillar, etc.) and positioned so that, when activated, an adhesive material of the reinforcing member expands and substantially fills a portion of the cavity to locally reinforce the one or more pillars. Alternatively, the adhesive material may be free of expansion and adhere the reinforcing member to the one or more pillars in a desired location requiring reinforcement. The desired location may be any portion of an article that may require reinforcement. For example, an article may be modeled using computer-aided engineering (CAE) software and a finite element analysis (FEA) may be generated to illustrate structural weak points of the article requiring reinforcement.

The reinforcing member may be any size and shape desired for an application. The reinforcing member may vary in thickness, width, length, height, or a combination thereof. The reinforcing member may include one or more arcuate portions, one or more contoured portions, one or more undulating portions, one or more cavities, one or more holes, one or more curved portions, one or more edges, one or more projections, one or more recesses, or a combination thereof. The reinforcing member may have a substantially uniform size and shape or may have a varying size and shape. For example, the reinforcing member may vary in size and shape between different segments of the reinforcing member. The reinforcing member may be substantially shaped to mate with an article being reinforced by the reinforcing member. For example, the reinforcing member may be substantially “C” shaped to be inserted into a substantially “C” shaped channel of a pillar of an automotive vehicle. The reinforcing member may be substantially “A” shaped, “C” shaped, “D” shaped, “P” shaped, “G” shaped, “V” shaped, “L” shaped, “U” shaped, or a combination thereof. The reinforcing member may have one or more arms, one or more fingers, one or more bends, one or more flanges, or a combination thereof.

The reinforcing member may include a carrier. The carrier may function to support an adhesive material of the reinforcing member. The carrier may function to reinforce an article of manufacture. The carrier may function as a substrate for the adhesive material of the reinforcing member. The carrier may structurally rigid. The carrier may be flexible. The carrier may be shaped similar to an adhesive material so that the adhesive material is disposed on a surface of the carrier. The carrier may mechanically secure the adhesive material to the carrier free of secondary fasteners, secondary adhesives, or both. The carrier may include one or more abrasive surfaces to increase friction between the adhesive material and the carrier. The carrier may include one or more holes, one or more cavities, or both. The carrier may be substantially planar or may include one or more contoured surfaces. The carrier may be injection molded, stamped, cast, extruded, pultruded, cut, or a combination thereof. The carrier may be formed from a polymer, metal, fibrous material, or a combination thereof. The carrier may include one or more layers disposed on each other to form the carrier. For example, the carrier may include a metal layer disposed on a polyamide layer. The carrier may be shaped to mate with a shape of one or more adhesive materials. The carrier be configured to secure the reinforcing member an article of manufacture being reinforced. For example, the carrier may include one or more connecting portions the connect the carrier to the article of manufacture. Alternatively, the carrier may be free of connecting portions and the carrier is connected to the article of manufacture via a friction-fit, interference-fit, or both. The reinforcing member may include a single carrier or may include a plurality of carriers. For example, the reinforcing member may include an adhesive a material sandwiched between opposing carriers. The carrier may be pre-treated prior to connection to the adhesive material. The carrier may be pre-treated using any surface treatments or treatment processes, such as degreasing, anodizing, galvanizing, phosphatizing, enameling, blackening, electroplating, chrome plating, nickel plating, plasma coating, sand blasting, cleaning, lapping, painting, or a combination thereof. The pre-treatment may be utilized to improve connection between the carrier and the adhesive material, one or more secondary components, the article being reinforced, or a combination thereof.

The adhesive material may function to adhere the reinforcing member to an article of manufacture so that the reinforcing member may reinforce the article of manufacture. The adhesive material may function to structurally reinforce an article of manufacture. The adhesive material may function to baffle noise of the reinforcing member, the article being reinforced, or both. The adhesive material may be shaped substantially similar to the carrier so that the adhesive material substantially covers one or more surfaces of the carrier. The adhesive material may be disposed on portion of the carrier. The adhesive material may include one or more connecting features to secure the adhesive material to the carrier, the carrier may include one or more connecting features to secure the adhesive material to the carrier, or both. The one or more connecting features may be a hook, latch, pin, column, flange, lip, fin, projection, hole, cavity, recess, or a combination thereof.

The adhesive material may be any adhesive material that forms a bond between the reinforcing member and the carrier, article being reinforced, or both. The adhesive material may be heat activatable, activated by an activating agent, or both. The adhesive material may be expandable upon activation. The adhesive material may be dry to the touch, non-tacky, or both prior to activation. The adhesive material may be room stable. The adhesive material may include an adhesive polymeric material (e.g., epoxy resin or the like). The adhesive material may include one or more of the following: an epoxy resin; a flexibilizer; a phenoxy resin; an impact modifier; a blowing agent; a curing agent; a filler; or a combination thereof. If the adhesive material is expandable or foamable, the adhesive material may expand to a volume greater than its volume in the unexpanded state (e.g., at least 5% greater, at least 20% greater or even possibly at least 50% greater). The volumetric expansion may be about 400% or less, about 300% or less, or about 200% or less relative to the original unexpanded volume. The volumetric expansion may be about 50% or more, about 100% or more, or about 150% or more relative to the original unexpanded volume. Alternatively, the volume of the adhesive material may be less after activation due to curing (e.g., cross-linking) for foamed and/or unfoamed versions of the adhesive material. A plurality of adhesive materials may be disposed on one or more surfaces of the carrier. Examples of adhesive materials may be found in U.S. Pat. Nos. 6,846,559; 6,923,499; 7,125,461; 7,199,165; 7,521,093; 7,892,396; 8,236,128; 8,334,055; 8,475,694; and 8,702,889, all of which are incorporated by reference herein for all purposes.

The carrier, adhesive material, or both may include one or more projections. The projections may function to connect the carrier to the adhesive material, or vice versa. The projections may structurally rigid. The projections may be elastically deformable. The projections may include one or more rigid portions and one or more elastically deformable portions. For example, the projections may include a rigid shaft having an elastically deformable mating portion disposed on a distal end of the shaft. The projections may be compressible. The projections may include one or more arcuate portions, one or more contoured portions, one or more undulating portions, one or more cavities, one or more holes, one or more curves portions, one or more edges, one or more projections, one or more recesses, or a combination thereof. The projections may be similar or shape or may differ. For example, a first set of projections may be hollow deformable columns while a second set of projections are substantially “T” shaped. The projections may be shaped to mate with a receiving portion of the carrier, adhesive material, or both. The projections may be integrally formed with the carrier, adhesive material, or both. The projections may be secured to the carrier, adhesive material, or both during a secondary operation of assembly. The projections may secure the carrier and adhesive material together so that an exposed portion of the projections are substantially coplanar with a surface of the adhesive material, carrier, or both, are recessed from a surface of the adhesive material, carrier, or both, protrude from a surface of the adhesive material, carrier, or both, or a combination thereof. The projections may extend substantially orthogonal to a surface of the carrier, adhesive material, or both. The projections may extend from a surface of the carrier, adhesive material, or both at an angle other than orthogonal. The projections may form an angle with a surface of the carrier, adhesive material, or both of about 30 degrees or more, about 45 degrees or more, or about 60 degrees or more. The projections may form an angle with a surface of the carrier, adhesive material, or both of about 135 degrees or less, about 120 degrees or less, or about 105 degrees or less. The projections may be positioned anywhere along the carrier, adhesive material, or both. The projections may project for a single surface of the carrier, adhesive material, or both or a plurality of surfaces of the carrier, adhesive material, or both.

One or more of the projections may include a shaft. The shaft may function connect a mating portion of the projection to the carrier, adhesive material, or both. The shaft may extend from the carrier, adhesive material, or both. The shaft may be integrally formed with the carrier, adhesive material, or both. The shaft may be received by one or more holes, one or more cavities, or both. For example, a shaft extending from the carrier may extend through a hole of the adhesive material so that a mating portion located on a distal end of the shaft abuts a surface of the adhesive material. The shaft may be structurally rigid or may be deformable. The shaft may be elastically or inelastically deformable. The shaft may be hollow or solid. The shaft may be any shape. The shaft may be any length. For example, the shaft may have a length substantially equal to a thickness of the adhesive material, carrier, or both. The shaft may have a length greater than or less than a thickness of the adhesive material, carrier, or both. The shaft may be substantially round, square, triangular, rectangular, oval, another shape, or a combination thereof. The shaft may have a diameter or width less than a diameter of one or more holes of the carrier, adhesive material, or both so that the shaft may be inserted and/or extend through the one or more holes. The shaft may have a width less than a width of a mating portion of the projection, greater than width of a mating portion of the projection, or both. The shaft may be substantially straight (i.e., linear) or may contain one or more bends, one or more arcuate portions, one or more angles, or a combination thereof.

The shaft may extend through one or more holes of the carrier, adhesive material, or both. The holes may function to receive the projection, secure the projection, or both. The holes may function to align the carrier and the adhesive material. For example, a plurality of projections integrally formed with the carrier may extend through a plurality of associated holes of the adhesive material so that the adhesive material is properly positioned to abut a surface of the carrier. The holes may be any size and shape to receive the projections. The holes may have a substantially uniform diameter or may vary. For example, the holes may have a tapered diameter so that the diameter of the hole gradually increases or decreases. The holes may act as a receiving portion to receive a mating portion of the projections. The holes may extend through an entire thickness of the carrier, adhesive material, or both. The holes may only partially extend through a thickness of the carrier, adhesive material, or both. The holes may extend substantially perpendicular to one or more surfaces of the carrier, adhesive material, or both. The holes may extend at an angle other than substantially perpendicular (i.e. about 90 degrees) to the one or more surfaces of the carrier, adhesive material, or both. The holes may include an internal threading that mates with a threading located on one or more projections. For example, the projections may include a threading along an outer surface of the shaft that is threaded to mate with the internal threading of the holes. The holes may include one or more lubricants. The holes may free of lubricants. The holes may elastically deform, inelastically deform, or be structurally rigid. The holes may have one or more rounded edges, chamfered edges, filleted edges, or a combination thereof. For example, the holes may have rounded edges along a surface of the carrier, adhesive material, or both so that projections be inserted into the holes remain undamaged when contacting the edges of the holes.

The shaft may connect to a mating portion of the projection. The mating portion may function to mate with a receiving portion of the carrier, adhesive material, or both. The mating portion may have a shape that substantially compliments a shape of the receiving portion. For example, the mating portion may have a substantially rounded shape the abuts a rounded surface of the receiving portion. The mating portion may be integrally formed with the shaft of the projection. The mating portion may be any desired size and shape. The mating portion may be round, planar, or both. The mating portion may include one or more fingers, one or more arms, one or more legs, one or more extensions, one or more arcuate portions, one or more bends, one or more contoured portions, one or more undulating portions, one or more flat portions, one or more flanges, one or more ridges, one or more steps, or a combination thereof. The mating portion may compressible. For example, the mating portion may have a width greater than a width of a hole so that the mating portion may be compressed to be inserted into the hole. The mating portion may then expand substantially back to its original width so that the mating portion is prevented from extending back through the hole. The mating portion may abut a receiving portion of the carrier, adhesive material, or both, one or more surfaces of the carrier, adhesive material, or both, or a combination thereof. The mating portion may be structurally rigid. The mating portion may be a clip, hook, latch, pin, or a combination thereof.

The mating portion may include a recess. The recess may function to promote desired deformation of a projection. For example, the projection may be a partially columnar projection having a depressed recess near a terminal end of the projection so that, when a force is applied to the terminal end of the projection, only a localized portion of the projection may be deformed to secure the adhesive material to the carrier. The recess may be any desired size or shape.

The mating portion may be secured in a receiving portion of the carrier, adhesive material, or both. The receiving portion may function to receive the mating portion and secure the adhesive material to the carrier, or vice versa. The receiving portion may be shaped to substantially follow a shape of the mating portion so that the mating portion abuts the receiving portion. The receiving portion may be any shape, height, width, or a combination thereof to receive the mating portion. The receiving portion may be structurally rigid or may be flexible. The receiving portion may be a cavity, hole, projection, recess, abutment, or a combination thereof. The mating portion may form a mechanical interlock with the receiving portion so that the carrier and adhesive material are mechanically secured to each other free of secondary fasteners, secondary adhesives, or both. The mechanical interlock may be a basic butt joint, mitered butt joint, half-lap joint, biscuit joint, tongue and groove joint, mortise and tenon joint, rabbet joint, dovetail joint, or a combination thereof. The receiving portion may prevent movement of the mating portion once the mating portion is secured in the receiving portion. Alternatively, the mating portion may be free to move in one or more directions once secured in the receiving portion. For example, the mating portion may be part of a projection of the adhesive material that is secured in a receiving portion of the carrier so that the carrier may pivot or hinge relative to the adhesive material. Therefore, the mating portion and receiving portion may form a movable joint such as a plane joint, hinge joint, saddle joint, pivot joint, condyloid joint, ball and socket joint, or a combination thereof. It is contemplated that a reinforcing member may be inserted into an article for reinforcement, and after insertion, the adhesive material may be pivoted while still connected to the carrier so that the adhesive material is positioned to structurally reinforce a desired location.

The receiving portion may be a cavity. The cavity may function to secure the mating portion of one or more projections. The cavity may be any size and shape. The cavity may be a hollowed channel of the carrier, adhesive material, or both. The cavity may be defined as any empty space located within the solid thickness of the carrier, adhesive material, or both. The cavity may be a chamber, pocket, pouch, crater, or a combination thereof. The cavity may be configured to substantially conform around a shape of the mating portion. For example, the mating portion may be bulbous in shape and the cavity may have a substantially hollow bulbous shape to abut an exterior surface of the mating portion. The cavity may have one or more open portions or may be free of open portions. For example, a pair of mating carriers may form a cavity therebetween to receive an adhesive material. The adhesive material may be inserted into the cavity prior to final joining of the pair of mating carriers.

The projections may be used in lieu of, or in conjunction with, one or more fins. The fins may function to secure the adhesive material to the carrier, or vice versa. The fins may be integrally formed with the carrier, adhesive material, or both. The fins may be secured to the carrier, adhesive material, or both. For example, the fins may be secured to the carrier, adhesive material, or both during an overmolding process. The fins may project from a surface of the carrier, adhesive material, or both. The fins may form an angle with the surface of the carrier, the adhesive material, or both. The fins may form an angle with a surface of the carrier, adhesive material, or both of about 30 degrees or more, about 45 degrees or more, or about 60 degrees or more. The fins may form an angle with a surface of the carrier, adhesive material, or both of about 135 degrees or less, about 120 degrees or less, or about 105 degrees or less. The fins may be structurally rigid. The fins may contain one or more flexible portions. The fins may have one or more pointed terminal edges so that the fins may pierce the adhesive material, carrier, or both and be inserted into the adhesive material, carrier, or both. The fins may be substantially linear or may include one or more arcuate portions. The fins may partially extend through a thickness of the adhesive material, carrier, or both. The fins may extend through an entire thickness of the adhesive material, carrier, or both so that the fins protrude from an opposing surface of the adhesive material, carrier, or both.

The fins may include a retaining portion. The retaining portion may function to retain the adhesive material on the carrier, or vice versa. The retaining portion may be positioned near a terminal end of the fins. The retaining portion may be an arcuate or curved portion of the fin that abuts a surface of the carrier, adhesive portion, or both. The retaining portion may be rigid or may be flexible. The retaining portion may be elastically or inelastically deformable. The retaining portion may have one or more teeth, one or more grooves, one or more ridges, or a combination thereof. The retaining portion may extend through the adhesive material, carrier, or both and protrude from a surface of the adhesive material, carrier, or both.

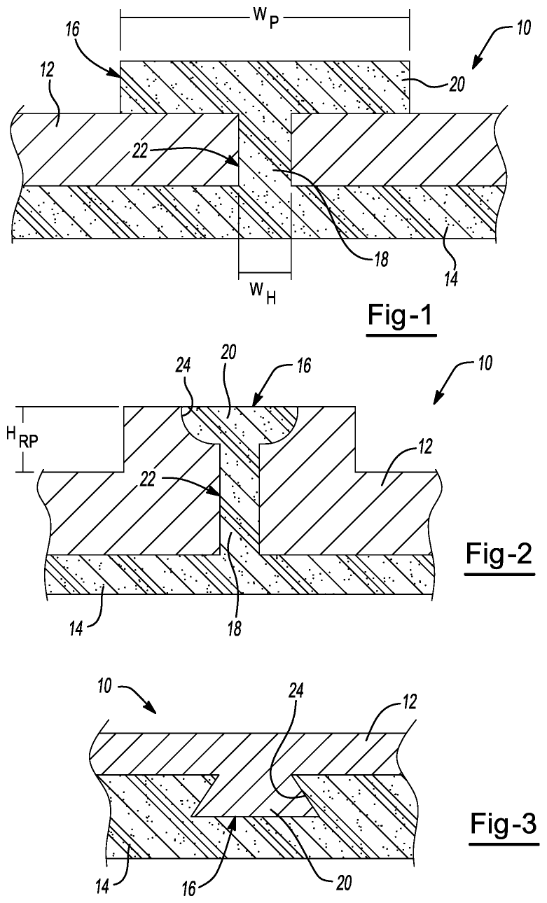

Turning now to the figures, FIG. 1 illustrates a segmented cross-sectional view of a reinforcing member 10. The reinforcing member 10 includes an adhesive material 14 secured to a carrier 12. The adhesive material 14 includes a projection 16 having a shaft 18 extending through a hole 22 of the carrier 12. A mating portion 20 of the projection 16 extends from the shaft 18 and abuts a surface of the carrier 12 so that the adhesive material 14 is secured to the carrier 12. It should be noted that the mating portion 20 of the projection 16 has a width (W_{P}) greater than a width of the hole (W_{H}) to prevent the adhesive material 14 from disconnecting from the carrier 12.

FIG. 2 illustrates a segmented cross-sectional view of a reinforcing member 10. The reinforcing member 10 includes an adhesive material 14 secured to a carrier 12. The adhesive material 14 includes a projection 16 having a shaft 18 extending through a hole 22 of the carrier 12. A mating portion 20 of the projection 16 extends from the shaft 18 and is secured in a receiving portion 24 of the carrier. The mating portion 20 includes a plurality of arcuate portions to form a substantially rounded mating portion 20 that is received by the receiving portion 24 having a complementary rounded shape. It should be noted that a height of the receiving portion (H_{RP}) may vary so that a top surface of mating portion 20 is coplanar with a top surface of the receiving portion 24, recessed from the top surface of the receiving portion 24, or protruding from the top surface of the receiving portion 24.

FIG. 3 illustrates a segmented cross-sectional view of a reinforcing member 10. The reinforcing member 10 includes an adhesive material 14 secured to a carrier 12. The carrier 12 includes a projection 16. A mating portion 20 of the projection 16 is received and secured by a receiving portion 24 of the adhesive material 14 so that unwanted movement of the adhesive material 14 relative to the carrier 12 is prevented. As shown, the mating portion 20 and the receiving portion 24 form a dovetail connection.

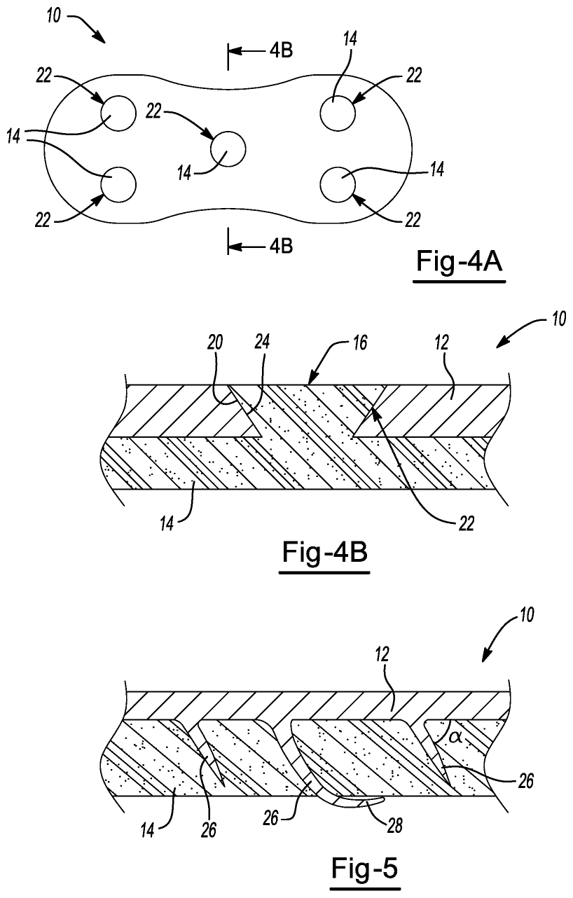

FIG. 4A illustrates a top view of a reinforcing member 10. The reinforcing member 10 includes a carrier 12 and an adhesive material 14. The carrier 12 includes a plurality of tapered holes 22 that secure a plurality of projections of the adhesive material 14 (see FIG. 4B).

FIG. 4B illustrates cross-sectional view 4B-4B of FIG. 1. The reinforcing member 10 includes a plurality of tapered holes 22 that secure a plurality of projections 16 of the adhesive material 14. A mating portion 20 of the projection 16 abuts a receiving portion 24 of the tapered holes 22 so that the adhesive material 14 is secured to the carrier 12.

FIG. 5 illustrates a segmented cross-sectional view of a reinforcing member 10. The reinforcing member 10 includes a carrier 12 and an adhesive material 14. The carrier 12 includes a plurality of fins 26 protruding from the carrier 12 to retain the adhesive material 14 disposed on the carrier 12. The fins 26 may include a retaining portion 28 that is configured to extend through the adhesive material 14 and compressibly secure the adhesive material 14 to the carrier 12. As shown, the fins 26 may extend through an entire thickness of the adhesive material 14, extend through only a portion of the thickness of the adhesive material 14, or both. The fins 26 may form an angle (a) with a surface of the carrier 12. The angle (a) may be substantially orthogonal to the surface of the carrier 12 or be an angle other substantially orthogonal to the surface of the carrier 12. As shown, the fins 26 may form an angle (a) with the surface of the carrier 12 so that the fins 26 penetrate through the adhesive material 14 at an angle other than substantially orthogonal to increase retention of the adhesive material 14 on the carrier 12, and prevent separation of the adhesive material 14 from the carrier 12.

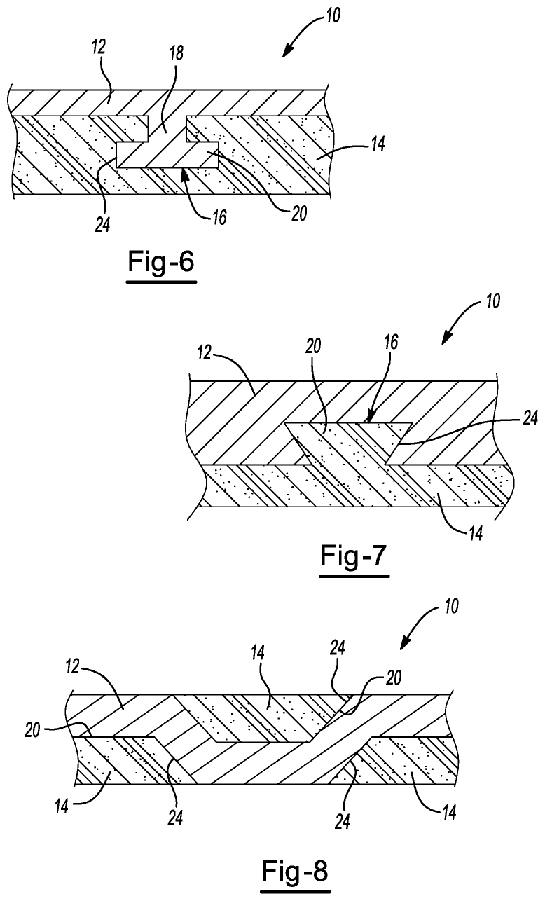

FIG. 6 illustrates a segmented cross-sectional view of a reinforcing member 10. The reinforcing member 10 includes a carrier 12 and an adhesive material 14. The carrier 12 includes a projection 16. The projection 16 includes a shaft 18 having a mating portion 20 disposed on an end of the shaft 18. The mating portion 20 is configured to be secured by a receiving portion 24 of the adhesive material to prevent movement of the adhesive material 14 relative to the carrier 12.

FIG. 7 illustrates a segmented cross-sectional view of a reinforcing member 10. The reinforcing member 10 includes an adhesive material 14 secured to a carrier 12. The adhesive material 14 includes a projection 16. A mating portion 20 of the projection 16 is received and secured by a receiving portion 24 of the carrier 14 so that unwanted movement of the adhesive material 14 relative to the carrier 12 is prevented. As shown, the mating portion 20 and the receiving portion 24 form a dovetail connection.

FIG. 8 illustrates a segmented cross-sectional view of a reinforcing member 10. The reinforcing member 10 includes a plurality of adhesive material sections 14 secured to the carrier. The plurality of adhesive material sections 14 may be sections of a continuous adhesive material 14, may be separate adhesive material portions 14, or both. The adhesive material 14 includes one or more surfaces that form a mating portion 20 that abut a plurality of surfaces of the carrier 12 that form a plurality of receiving portions 24 to secure the adhesive material 14 to the carrier 12. As shown, the adhesive material 14 may abut opposing surfaces of the carrier 12.

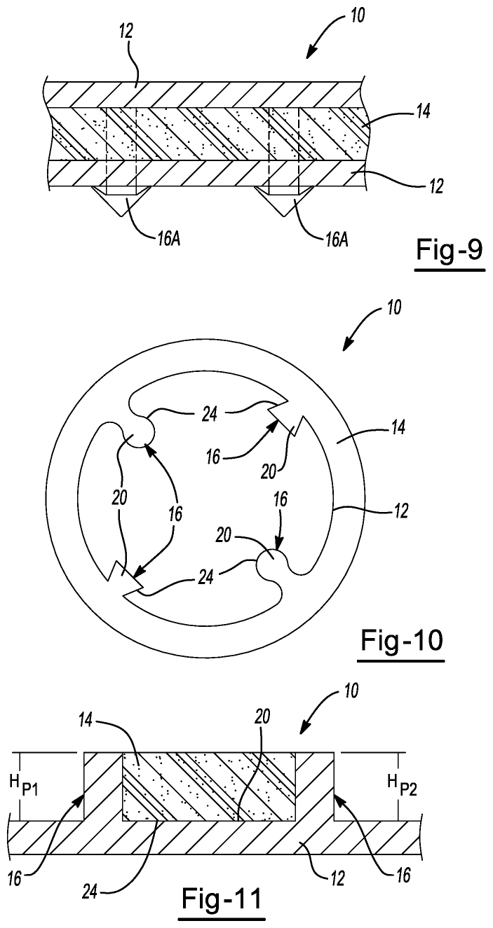

FIG. 9 illustrates a segmented cross-sectional view of a reinforcing member 10. The reinforcing member 10 includes an adhesive material 14 secured between opposing carriers 12. A plurality of projections 16 shown as clips 16A project from a first carrier 12 and extend through the adhesive material 14 and an opposing second carrier 12 so that the clips 16A secure both the adhesive material 14 and the second carrier 12 to the first carrier 12.

FIG. 10 illustrates a cross-sectional view of a reinforcing member 10. The reinforcing member 10 includes an adhesive material 14 encompassing a carrier 12. The adhesive material 14 includes a plurality of projections 16. Each projection 16 includes a mating surface 20 configured to be received in, and secured by, a plurality of respective receiving portions 24 of the carrier 12. As shown, the mating portions 20 and their respective receiving portions 24 may be shaped substantially similar or different to form a dovetail connection, substantially rounded bulbous connection, or both.

FIG. 11 illustrates a segmented cross-sectional view of a reinforcing member 10. The reinforcing member 10 includes an adhesive material 14 disposed on a carrier 12. The carrier 12 includes a plurality of projections 16 that form a receiving portion 24 of the carrier 12. The adhesive material 14 is disposed in the receiving portion 24 so that a mating portion 20 of the adhesive material 14 abuts the receiving portion 24 of the carrier 12 and secures the adhesive material 14 to the carrier 12. It should be noted that while the projections 16 as shown have a substantially equal height (i.e., H_{P1} and H_{P2} are substantially equal), the projections 16 may have dissimilar heights.

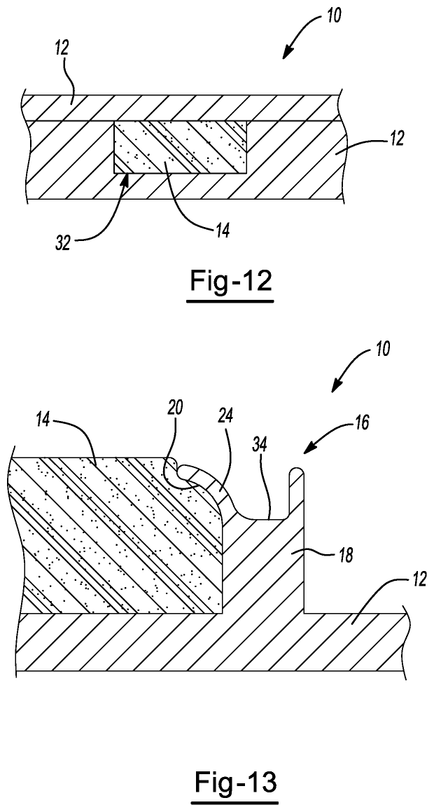

FIG. 12 illustrates a segmented cross-sectional view of a reinforcing member 10. The reinforcing member 10 includes a pair of carriers 12 secured to one another that form a cavity 32. An adhesive material 14 is secured within the cavity 32. It should be noted that one or more portions of the cavity 32 may be open so that the adhesive material 14 may be inserted into the cavity 32. However, it is also contemplated that the adhesive material 14 may be inserted into a cavity 32 free of open portions prior to joining the carriers 12 to each other.

FIG. 13 illustrates a segmented cross-sectional view of a reinforcing member 10. The reinforcing member 10 includes an adhesive material 14 disposed on a carrier 12. The carrier 12 includes a columnar projection 16 extending away from a surface of the carrier 12. The projection 16 includes an at least partially hollow shaft 18 that forms a recess 34 encompassed by a deformable outer receiving portion 24. The adhesive material 14 includes a mating portion 20 configured to mate with the receiving portion 24 of the projection 16. As shown, all or a portion of the receiving portion 24 may be deformable to abut the mating portion 20 of the adhesive material 14 and secure the adhesive material 14 to the carrier. It should be noted that the projection 16 prior to deformation, after deformation, or both may be recessed from an outer surface of the adhesive material 14, protrude from an outer surface of the adhesive material 14, or both.

The explanations and illustrations presented herein are intended to acquaint others skilled in the art with the invention, its principles, and its practical application. The above description is intended to be illustrative and not restrictive. Those skilled in the art may adapt and apply the invention in its numerous forms, as may be best suited to the requirements of a particular use.

Accordingly, the specific embodiments of the present invention as set forth are not intended as being exhaustive or limiting of the teachings. The scope of the teachings should, therefore, be determined not with reference to this description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

Plural elements or steps can be provided by a single integrated element or step. Alternatively, a single element or step might be divided into separate plural elements or steps.

The disclosure of “a” or “one” to describe an element or step is not intended to foreclose additional elements or steps.

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The disclosures of all articles and references, including patent applications and publications, are incorporated by reference for all purposes. Other combinations are also possible as will be gleaned from the following claims, which are also hereby incorporated by reference into this written description.

Unless otherwise stated, a teaching with the term “about” or “approximately” in combination with a numerical amount encompasses a teaching of the recited amount, as well as approximations of that recited amount. By way of example, a teaching of “about 100” encompasses a teaching of within a range of 100+/−15.

### ELEMENT LIST

10 Reinforcing Member
12 Carrier
14 Adhesive Material
16 Projection
16A Clip
18 Shaft
20 Mating Portion
22 Hole
24 Receiving Portion
26 Fin
28 Retaining Portion
32 Cavity
34 Recess
W_{H} Width of the Hole
W_{P} Width of the Projection
H_{RP} Height of the Receiving Portion
H_{P1,2} Height of the Projection
α Angle of the Fin

What is claimed is:

1. A reinforcing member comprising:
(a) a carrier; and
(b) an adhesive material disposed on the carrier,
wherein the carrier or the adhesive material includes one or more integrally formed projections configured to mechanically secure the adhesive material to the carrier.

2. The reinforcing member according to claim 1, wherein the adhesive material includes the one or more projections.

3. The reinforcing member according to claim 1, wherein the carrier includes the one or more projections.

4. The reinforcing member according to claim 2, wherein the one or more projections each include a shaft that extends through a respective hole of the carrier.

5. The reinforcing member according to claim 3, wherein the one or more projections each include a shaft that extends through a respective hole of the adhesive material.

6. The reinforcing member according to claim 2, wherein the one or more projections each include a mating portion that is received by a receiving portion of the carrier, and the receiving portion has a complimentary shape that substantially follows and abuts a shape of the mating portion.

7. The reinforcing member according to claim 3, wherein the one or more projections each include a mating portion that is received by a receiving portion of the adhesive material, and the receiving portion has a complimentary shape that substantially follows and abuts a shape of the mating portion.

8. The reinforcing member according to claim 1, wherein the one or more projections are elastically deformable.

9. The reinforcing member according to claim 1, wherein the adhesive material is a thermally expandable material.

10. The reinforcing member according to claim 6, wherein the mating portion and the receiving portion form a dovetail interface.

11. The reinforcing member according to claim 6, wherein the mating portion and the receiving portion form a dovetail interface.

12. The reinforcing member according to claim 1, wherein the one or more projections are a compressible clip.

13. The reinforcing member according to claim 1, wherein the adhesive material encompasses an exterior profile of the carrier.

14. A reinforcing member comprising:
(a) a carrier having one or more receiving portions; and
(b) an adhesive material disposed on the carrier, the adhesive material having one or more integrally formed projections configured to mechanically secure the adhesive material to the carrier, the one or more projections each comprising a mating portion located near an end of the projection opposing the surface of the adhesive material,
wherein each of the one or more projections extend through a respective hole of the carrier and the mating portion of each of the one or more projections has a width greater than a width of their respective hole;
wherein the mating portions are received by the one or more receiving portions, and the one or more receiving portions have a complimentary shape that substantially follows and abuts a shape of the mating portion so that the adhesive material is mechanically interlocked to the carrier; and
wherein the reinforcing member is free of secondary fasteners the secure the adhesive material to the carrier.

15. The reinforcing member according to claim 14, wherein the holes of the carrier are tapered and the one or more projections are shaped substantially to follow the taper of the holes so that a top surface of the one or more projections is coplanar with a top surface of the carrier.

16. The reinforcing member according to claim 14, wherein the one or more receiving portions are an outermost profile of the carrier.

17. The reinforcing member according to claim 14, wherein the one or more receiving portions are integrally formed with the carrier.

18. The reinforcing member according to claim 14, wherein the carrier is a pair or carriers secured to one another and the one or more receiving portions are a cavity formed between the pair of carriers.

19. The reinforcing member according to claim 14, wherein the adhesive material is a thermally expandable material.

20. The reinforcing member according to claim 14, wherein the one or more projections are elastically deformable.
